(19) United States
(12) Patent Application Publication
(10) Pub. No.: US 2023/0416465 A1
(43) Pub. Date: Dec. 28, 2023

(54) POLYAMIC ACID COMPOSITION, AND POLYIMIDE COMPRISING SAME

(71) Applicant: PI ADVANCED MATERIALS CO., LTD., Chungcheongbuk-do (KR)

(72) Inventors: In Hwan HWANG, Seoul (KR); Ik Sang LEE, Gyeongsangbuk-do (KR)

(21) Appl. No.: 18/037,874

(22) PCT Filed: Nov. 27, 2020
(86) PCT No.: PCT/KR2020/017159

§ 371 Date: May 19, 2023

(30) Foreign Application Priority Data
Nov. 19, 2020 (KR) 10 2020 0155542

(51) Int. Cl. C08G 73/10; C08K 3/40; C08L 79/08; C08J 5/18

(52) U.S. Cl. CPC C08G 73/1067; C08G 73/1032; C08K 3/40; C08L 79/08; C08J 5/18; C08K 2201/003; C08L 2201/08; C08L 2203/16; C08L 2203/20

(57) ABSTRACT

The present application relates to a polyamic acid composition and a polyimide comprising same, and provides a polyamic acid composition which has a high concentration of polyamic acid solids and a low viscosity and, after hardening, has superior heat resistance, dimensional stability, and mechanical properties, and a polyimide and a polyimide film produced therefrom.

### CROSS-REFERENCE TO RELATED APPLICATION

This application claims priority to and the benefit of Korean Patent Application No. 10-2020-0155542, filed on Nov. 19, 2020, the disclosures of which are incorporated herein by reference in their entireties.

### TECHNICAL FIELD

The present application relates to a polyamic acid composition and a polyimide including the same.

### BACKGROUND ART

Polyimides (PIs) are polymer materials, which are based on a rigid aromatic main chain and have heat stability, and have excellent mechanical properties such as strength, chemical resistance, weather resistance, heat resistance, and the like based on chemical stability of an imide ring.

In addition, polyimides are in the spotlight as high-functional polymer materials applicable in a wide range of industrial fields, such as electronics, communications, and optics, due to having excellent electrical properties such as insulating properties and low permittivity.

In recent years, as various electronic devices have become thinner, lighter and smaller, many studies have been conducted to use a polyimide thin film, which is lightweight and has excellent flexibility, as a display substrate capable of replacing an insulating material of a circuit board or a glass substrate for a display.

Particularly, in the case of a polyimide film used in a circuit board or display substrate manufactured at a high process temperature, it is necessary to secure higher levels of dimensional stability, heat resistance, and mechanical properties.

As one method for securing the material properties, a method of increasing the molecular weight of a polyimide may be exemplified.

Since the heat resistance and mechanical properties of a polyimide film can be enhanced as more imide groups are present in the molecule, and an imide group ratio is increased as a polymer chain becomes longer, preparation of a polyimide having a high molecular weight is desirable for securing material properties.

In order to prepare a polyimide having a high molecular weight, it is common to prepare polyamic acid, which is a precursor of a polyimide, to have a high molecular weight and then imidize it by thermal treatment.

However, as the molecular weight of polyamic acid is higher, the viscosity of a polyamic acid solution in which polyamic acid is dissolved in a solvent increases, and thus a problem in that fluidity is degraded and process handling is highly degraded arises.

In addition, to lower the viscosity of polyamic acid while maintaining the molecular weight of polyamic acid, a method of decreasing a solid content and increasing a solvent content may be considered. However, this method may have a problem in that a manufacturing cost and a process time increase because a large amount of solvent needs to be removed in a curing process.

Therefore, there is an urgent need to develop a polyimide film which satisfies processability by maintaining low viscosity despite a high solid content of a polyamic acid solution and simultaneously satisfies the heat resistance and mechanical properties of a polyimide prepared from the polyamic acid solution.

### DISCLOSURE

### Technical Problem

The present application is directed to providing a polyamic acid composition, which has a high concentration of polyamic acid solid and low viscosity and is excellent in heat resistance, dimensional stability, and mechanical properties after curing, and a polyimide and a polyimide film, which are prepared therefrom.

### Technical Solution

The present application relates to a polyamic acid composition. A polyamic acid composition according to the present application may include polyamic acid including a dianhydride monomer component and a diamine monomer component as a polymerization unit. Also, the polyamic acid composition may include a solvent, and the solvent may include a first solvent having a boiling point of 150° C. or more and a second solvent having a boiling point lower than that of the first solvent. The second solvent may have a boiling point of 30° C. or more and less than 150° C. The lower limit of the boiling point of the first solvent may be, for example, 155° C., 160° C., 165° C., 170° C., 175° C., 180° C., 185° C., 190° C., 195° C., 200° C., or 201° C. or more, and the upper limit thereof may be, for example, 500° C., 450° C., 300° C., 280° C., 270° C., 250° C., 240° C., 230° C., 220° C., 210° C., or 205° C. or less. Also, the lower limit of the boiling point of the second solvent may be, for example, 35° C., 40° C., 45° C., 50° C., 53° C., 58° C., 60° C., or 63° C. or more, and the upper limit thereof may be, for example, 148° C., 145° C., 130° C., 120° C., 110° C., 105° C., 95° C., 93° C., 88° C., 85° C., 80° C., 75° C., 73° C., 70° C., or 68° C. or less. In the present application, a polyimide having desired material properties can be prepared by using two types of solvents having mutually different boiling points.

In addition, in an example, the second solvent may have a solubility of less than 1.5 g/100 g with respect to the dianhydride monomer. In other words, the second solvent may have a solubility of less than 1.5 g/100 g with respect to the dianhydride monomer. The upper limit of the solubility may be, for example, 1.3 g/100 g, 1.2 g/100 g, 1.1 g/100 g, 1.0 g/100 g, 0.9 g/100 g, 0.8 g/100 g, 0.7 g/100 g, 0.6 g/100 g, 0.5 g/100 g, 0.4 g/100 g, 0.3 g/100 g, 0.25 g/100 g, 0.23 g/100 g, 0.21 g/100 g, 0.2 g/100 g, or 0.15 g/100 g or less, and the lower limit thereof may be, for example, 0 g/100 g, 0.01 g/100 g, 0.05 g/100 g, 0.08 g/100 g, 0.09 g/100 g, or 0.15 g/100 g or more. In the present application, a polyamic acid composition having desired material properties can be provided by including a second solvent having a low solubility with respect to the dianhydride monomer included as a polymerization unit or an unpolymerized dianhydride monomer. When the material properties measured in the present application are affected by temperature, they may be measured at room temperature such as 23° C. unless otherwise specified.

In an embodiment of the present application, the first solvent may have, for example, a solubility of 1.5 g/100 g or more with respect to the dianhydride monomer. The lower limit of the solubility may be, for example, 1.6 g/100 g, 1.65 g/100 g, 1.7 g/100 g, 2 g/100 g, 2.5 g/100 g, 5 g/100 g, 10 g/100 g, 30 g/100 g, 45 g/100 g, 50 g/100 g, or 51 g/100 g or more, and the upper limit thereof may be, for example, 80 g/100 g, 70 g/100 g, 60 g/100 g, 55 g/100 g, 53 g/100 g, 48 g/100 g, 25 g/100 g, 10 g/100 g, 5 g/100 g, or 3 g/100 g or less. The solubility of the first solvent may be higher than that of the second solvent.

In an example, the second solvent may have at least one polar functional group selected from the group consisting of a hydroxyl group, a carboxyl group, an alkoxy group, an ester group, and an ether group. The first solvent may be a component different from the second solvent. In the present application, a polyamic acid composition having desired material properties can be provided by including a first solvent and a second solvent which are mutually different components and limiting the type of a functional group of the second solvent. The solvent may be an organic solvent, but the present invention is not limited thereto. The second solvent may be included in an amount of 0.01 to 10 wt % in the entire polyamic acid composition. The lower limit of the content of the second solvent may be, for example, 0.015 wt %, 0.03 wt %, 0.05 wt %, 0.08 wt %, 0.1 wt %, 0.3 wt %, 0.5 wt %, 0.8 wt %, 1 wt %, or 2 wt % or more, and the upper limit thereof may be, for example, 10 wt %, 9 wt %, 8 wt %, 7 wt %, 6 wt %, 5.5 wt %, 5.3 wt %, 5 wt %, 4.8 wt %, 4.5 wt %, 4 wt %, 3 wt %, 2.5 wt %, 1.5 wt %, 1.2 wt %, 0.95 wt %, or 0.4 wt % or less. Also, the first solvent may be included in an amount of 60 to 95 wt % in the entire polyamic acid composition. The lower limit of the content of the first solvent may be, for example, 65 wt %, 68 wt %, 70 wt %, 73 wt %, 75 wt %, 78 wt %, or 80 wt %, or more, and the upper limit thereof may be, for example, 93 wt %, 90 wt %, 88 wt %, 85 wt %, 83 wt %, 81 wt %, or 79 wt % or less. The polyamic acid composition according to the present application includes a dianhydride monomer component and a diamine monomer component, and the two types of monomers constitute a polymerization unit. However, some of the dianhydride monomer is ring-opened by the organic solvent and thus is not able to participate in the polymerization reaction. The unpolymerized and ring-opened dianhydride monomer may act as a dilution monomer to adjust the viscosity of the entire polyamic acid composition to be relatively low. The dianhydride monomer having a ring-opening structure may participate in an imidization reaction to implement a desired polyimide.

As described above, the dianhydride monomer may include an unpolymerized monomer having a ring-opening structure in addition to the monomer included in the polymerization unit. In other words, some of the dianhydride monomer may be included in a polymerization unit, the rest may not be included in a polymerization unit, and the dianhydride monomer that is not included in a polymerization unit may be ring-opened by the second solvent. In the polyamic acid composition according to the present application, the dianhydride monomer may be present in the form of an aromatic carboxylic acid having two or more carboxylic acids when unpolymerized, and the aromatic carboxylic acid may be present as a monomer before curing, thereby lowering the viscosity of the entire polyamic acid composition and enhancing processability. The aromatic carboxylic acid having two or more carboxylic acids may be polymerized into a dianhydride monomer in a main chain after curing to increase the length of the entire polymer chain, and thus the polymer may implement excellent heat resistance, dimensional stability, and mechanical properties.

Specifically, when thermal treatment is performed for imidization of the polyamic acid composition into a polyimide, the aromatic carboxylic acid having two or more carboxylic acids is processed into a dianhydride monomer through a ring-closing dehydration reaction, and the dianhydride monomer reacts with the terminal amine group of a polyamic acid chain or polyimide chain, and thus the length of a polymer chain is increased. As a result, the dimensional stability and high-temperature heat stability of a prepared polyimide film can be improved, and room-temperature mechanical properties can be enhanced.

As described above, the polyamic acid composition according to the present application may include a diamine monomer and a dianhydride monomer as a polymerization unit. In the specification, “polyimide precursor composition” may be used with the same meaning as “polyamic acid composition” or “polyamic acid solution.”

The dianhydride monomer that may be used in preparation of the polyamic acid solution may be aromatic tetracarboxylic dianhydride, and the aromatic tetracarboxylic dianhydride may be, for example, pyromellitic dianhydride (or PMDA), 3,3′,4,4′-biphenyltetracarboxylic dianhydride (or BPDA), 2,3,3′,4′-biphenyltetracarboxylic dianhydrde (or a-BPDA), oxydiphthalic dianhydride (or ODPA), diphenylsulfone-3,4,3′,4′-tetracarboxylic dianhydride (or DSDA), bis(3,4-dicarboxyphenyl)sulfide dianhydride, 2,2-bis(3,4-dicarboxyphenyl)-1,1,1,3,3,3-hexafluoropropane dianhydride, 2,3,3′,4′-benzophenonetetracarboxylic dianhydride, 3,3′,4,4′-benzophenonetetracarboxylic dianhydride (or BTDA), bis(3,4-dicarboxyphenyl)methane dianhydride, 2,2-bis(3,4-dicarboxyphenyl)propane dianhydride, p-phenylenebis(trimellitic monoester acid anhydride), p-biphenylenebis(trimellitic monoester acid anhydride), m-terphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis[(3,4-dicarboxyphenoxy)phenyl]propane dianhydride (BPADA), 2,3,6,7-naphthalenetetracarboxylic dianhydride, 1,4,5,8-naphthalenetetracarboxylic dianhydride, 4,4′-(2,2-hexafluoroisopropylidene)diphthalic dianhydride, or the like.

As necessary, those listed above may be used alone or in a combination of two or more as the dianhydride monomer, and for example, pyromellitic dianhydride (PMDA), 3,3′,4,4′-biphenyltetracarboxylic dianhydride (s-BPDA), 2,3,3′,4′-biphenyltetracarboxylicdianhydride (a-BPDA), 3,3′,4,4′-benzophenonetetracarboxylic dianhydride (BTDA), oxydiphthalic dianhydride (ODPA), 4,4-(hexafluoroisopropylidene)diphthalic anhydride (6-FDA), or p-phenylenebis(trimellitate anhydride) (TAHQ) may be included.

In an embodiment of the present application, the dianhydride monomer may include a dianhydride monomer having one benzene ring and a dianhydride monomer having two or more benzene rings. The dianhydride monomer having one benzene ring and the dianhydride monomer having two or more benzene rings may be included in amounts of 20 to 60 mol % and 40 to 90 mol %; 25 to 55 mol % and 45 to 80 mol %; or 35 to 53 mol % and 48 to 75 mol %, respectively. In the present application, both excellent adhesive strength and desired levels of mechanical properties can be implemented by including the dianhydride monomer.

In addition, the diamine monomer that may be used in preparation of the polyamic acid solution is an aromatic diamine and may be classified as follows:
1) a diamine having one benzene nucleus in the structure and a relatively rigid structure, such as 1,4-diaminobenzene (or p-phenylenediamine (PDA)). 1,3-diaminobenzene, 2,4-diaminotoluene, 2,6-diaminotoluene, 3,5-diaminobenzoic acid (or DABA), or the like;
2) a diamine having two benzene nuclei in the structure, such as a diaminodiphenyl ether such as 4,4′-diaminodiphenyl ether (or oxydianiline (ODA)), 3,4′-diaminodiphenyl ether, or the like, 4,4′-diaminodiphenylmethane(methylenediamine), 3,3′-dimethyl-4,4′-diaminobiphenyl, 2,2′-dimethyl-4,4′-diaminobiphenyl, 2,2′-bis(trifluoromethyl)-4,4′-diaminobiphenyl, 3,3′-dimethyl-4,4′-diaminodiphenylmethane, 3,3′-dicarboxy-4,4′-diaminodiphenylmethane, 3,3′,5,5′-tetramethyl-4,4′-diaminodiphenylmethane, bis(4-aminophenyl)sulfide, 4,4′-diaminobenzanilide, 3,3′-dichlorobenzidine, 3,3′-dimethylbenzidine (or o-tolidine), 2,2′-dimethylbenzidine (or m-tolidine), 3,3′-dimethoxybenzidine, 2,2′-dimethoxybenzidine, 3,3′-diaminodiphenyl ether, 3,4′-diaminodiphenyl ether, 4,4′-diaminodiphenyl ether, 3,3′-diaminodiphenylsulfide, 3,4′-diaminodiphenylsulfide, 4,4′-diaminodiphenylsulfide, 3,3′-diaminodiphenylsulfone, 3,4′-diaminodiphenylsulfone, 4,4′-diaminodiphenylsulfone, 3,3′-diaminobenzophenone, 4,4′-diaminobenzophenone, 3,3′-diamino-4,4′-dichlorobenzophenone, 3,3′-diamino-4,4′-dimethoxybenzophenone, 3,3′-diaminodiphenylmethane, 3,4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1,1,1,3,3,3-hexafluoropropane, 2,2-bis(4-aminophenyl)-1,1,1,3,3,3-hexafluoropropane, 3,3′-diaminodiphenyl sulfoxide, 3,4′-diaminodiphenyl sulfoxide, 4,4′-diaminodiphenyl sulfoxide, or the like;
3) a diamine having three benzene nuclei in the structure, such as 1,3-bis(3-aminophenyl)benzene, 1,3-bis(4-aminophenyl)benzene, 1,4-bis(3-aminophenyl)benzene, 1,4-bis(4-aminophenyl)benzene, 1,3-bis(4-aminophenoxy)benzene, 1,4-bis(3-aminophenoxy)benzene (or TPE-Q), 1,4-bis(4-aminophenoxy)benzene (or TPE-Q), 1,3-bis(3-aminophenoxy)-4-trifluoromethylbenzene, 3,3′-diamino-4-(4-phenyl)phenoxybenzophenone, 3,3′-diamino-4,4′-di(4-phenylphenoxy)benzophenone, 1,3-bis(3-aminophenylsulfide)benzene, 1,3-bis(4-aminophenylsulfide)benzene, 1,4-bis(4-aminophenylsulfide)benzene, 1,3-bis(3-aminophenylsulfone)benzene, 1,3-bis(4-aminophenylsulfone)benzene, 1,4-bis(4-aminophenylsulfone)benzene, 1,3-bis[2-(4-aminophenyl)isopropyl]benzene, 1,4-bis[2-(3-aminophenyl)isopropyl]benzene, 1,4-bis[2-(4-aminophenyl)isopropyl]benzene, or the like; and
4) a diamine having four benzene nuclei in the structure, such as 3,3′-bis(3-aminophenoxy)biphenyl, 3,3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, bis[3-(3-aminophenoxy)phenyl]ketone, bis[3-(4-aminophenoxy)phenyl]ketone, bis[4-(3-aminophenoxy)phenyl]ketone, bis[4-(4-aminophenoxy)phenyl]ketone, bis[3-(3-aminophenoxy)phenyl]sulfide, bis[3-(4-aminophenoxy)phenyl]sulfide, bis [4-(3-aminophenoxy)phenyl]sulfide, bis[4-(4-aminophenoxy)phenyl]sulfide, bis[3-(3-aminophenoxy)phenyl]sulfone, bis[3-(4-aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-aminophenoxy)phenyl]propane, 2,2-bis[4-(4-aminophenoxy)phenyl]propane (BAPP), 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[4-(3-aminophenoxy)phenyl]-1,1,1,3,3,3-hexafluoropropane, 2,2-bis[4-(4-aminophenoxy)phenyl]-1,1,1,3,3,3-hexafluoropropane, or the like.

In an example, the diamine monomer according to the present application may include 1,4-diaminobenzene (PPD), 1,3-diaminobenzene (MPD), 2,4-diaminotoluene, 2,6-diaminotoluene, 4,4′-diaminodiphenyl ether (ODA), 4,4′-methylenediamine (MDA), 4,4-diaminobenzanilide (4,4-DABA), N,N-bis(4-aminophenyl)benzene-1,4-dicarboxamide (BPTPA), 2,2-dimethylbenzidine (M-TOLIDINE), or 2,2-bis(trifluoromethyl)benzidine (TFDB).

In an embodiment, the polyamic acid composition may have a solid content of 9 to 35 wt %, 10 to 33 wt %, 10 to 30 wt %, 15 to 25 wt %, or 18 to 23 wt % based on the total weight. In the present application, as a solid content of the polyamic acid composition is adjusted to be relatively high, a viscosity increase can be controlled while desired levels of material properties after curing are maintained, and an increase in a manufacturing cost and process time, which is caused by removing a large amount of solvent in a curing process, can be prevented.

The polyamic acid composition according to the present application may be a composition having low viscosity. The polyamic acid composition according to the present application may have a viscosity of 50,000 cP or less, 40,000 cP or less, 30,000 cP or less, 20,000 cP or less, 10,000 cP or less, or 9,000 cP or less as measured at a temperature of 23° C. and a shear rate of 1 s⁻¹. Although there is no particular limitation on the lower limit of the viscosity, the lower limit may be 500 cP or more or 1000 cP or more. The viscosity may be measured, for example, using Rheostress 600 commercially available from Haake and measured under conditions of a shear rate of 1/s, a temperature of 23° C., and a plate gap of 1 mm. In the present application, as the viscosity is adjusted within the above range, when a precursor composition having excellent processability is provided to form a film or substrate, a film or substrate having desired material properties can be formed.

In an embodiment, the polyamic acid composition according to the present application may have a weight-average molecular weight of 10,000 to 500,000 g/mol, 15,000 to 400,000 g/mol, 18,000 to 300,000 g/mol, 20,000 to 200,000 g/mol, 25,000 to 100,000 g/mol, or 30,000 to 80,000 g/mol after curing. In the present application, the term “weight-average molecular weight” refers to a value converted with respect to standard polystyrene as measured by gel permeation chromatography (GPC).

The first solvent according to the present application is not particularly limited as long as it is a solvent in which polyamic acid is able to be dissolved. The first solvent may also be a polar solvent. For example, an amide solvent such as N,N-dimethylformamide, N,N-dimethylacetamide, N-methylpyrrolidone, or the like may be exemplified as the first solvent. For example, the first solvent may have an amide group or a ketone group in the molecular structure. The first solvent may have polarity lower than that of the second solvent.

In an example, the first solvent may be an aprotic polar solvent. The second solvent may be an aprotic polar solvent or a protic polar solvent. Examples of the second solvent may include: an alcohol-based solvent such as methanol, ethanol, 1-propanol, butyl alcohol, isobutyl alcohol, or 2-propanol; an ester-based solvent such as methyl acetate, ethyl acetate, isopropyl acetate, or the like; a carboxylic acid solvent such as formic acid, acetic acid, propionic acid, butyric acid, lactic acid, or the like; an ether-based solvent such as dimethyl ether, diethyl ether, diisopropyl ether, dimethoxyethane methyl t-butyl ether, or the like; or dimethyl carbonate, methyl methacrylate, or propylene glycol monomethyl ether acetate.

In the present application, both the first solvent and the second solvent may be included. In this case, the first solvent may be included in a larger amount than the second solvent. Also, the second solvent may be included in an amount of 0.01 to 10 parts by weight with respect to 100 parts by weight of the first solvent. The lower limit of the content may be, for example, 0.02 parts by weight, 0.03 parts by weight, 0.04 parts by weight, 0.1 parts by weight, 0.3 parts by weight, 0.5 parts by weight, 0.8 parts by weight, 1 part by weight, or 2 parts by weight or more, and the upper limit thereof may be, for example, 8 parts by weight, 6 parts by weight, 5 parts by weight, 4.5 parts by weight, 4 parts by weight, 3 parts by weight, 2.5 parts by weight, 1.5 parts by weight, 1.2 parts by weight, 0.95 parts by weight, 0.4 parts by weight, 0.15 parts by weight, or 0.09 parts by weight or less.

The polyamic acid composition according to the present application may further include inorganic particles. The inorganic particles may have, for example, an average particle diameter of 5 to 80 nm. In an embodiment, the lower limit of the average particle diameter may be 8 nm, 10 nm, 15 nm, 18 nm, 20 nm, or 25 nm or less, and the upper limit thereof may be, for example, 70 nm, 60 nm, 55 nm, 48 nm, or 40 nm or less. In the specification, the average particle diameter may be measured by D50 particle size analysis. In the present application, as the particle diameter range is adjusted, compatibility with polyamic acid can be increased, and desired material properties can be implemented after curing.

Although the type of the inorganic particles is not particularly limited, silica, alumina, titanium dioxide, zirconia, yttria, mica, clay, zeolite, chromium oxide, zinc oxide, iron oxide, magnesium oxide, calcium oxide, scandium oxide, or barium oxide may be included. Also, the inorganic particle of the present application may include a surface treatment agent in the surface. The surface treatment agent may include, for example, a silane coupling agent. The silane coupling agent may be one or two or more selected from the group consisting of epoxy-based, amino-based, and thiol-based compounds. Specifically, the epoxy-based compound may include glycidyloxypropyl trimethoxysilane (GPTMS), the amino-based compound may include aminopropyl trimethoxysilane ((3-aminopropyl)trimethoxy-silane (APTMS)), and the thiol-based compound may include mercaptopropyl trimethoxysilane (MPTMS), but the present invention is not limited thereto. Also, the surface treatment agent may include dimethyldimethoxysilane (DMDMS), methyltrimethoxysilane (MTMS), methyltriethoxysilane (MTES), or tetraethoxysilane (TEOS). In the present application, the inorganic particles may be surface-treated by treating the surface with one type of a surface treatment agent or two different types of surface treatment agents. Also, the inorganic particles may be included in an amount of 1 to 20 parts by weight with respect to 100 parts by weight of polyamic acid. The lower limit of the content may be, for example, 3 parts by weight, 5 parts by weight, 8 parts by weight, 9 parts by weight, or 10 parts by weight or more, and the upper limit thereof may be, for example, 18 parts by weight, 15 parts by weight, 13 parts by weight, or 8 parts by weight or less. In the present application, as the inorganic particles are included in the polyamic acid composition, dispersibility and miscibility can be enhanced, and adhesion and heat resistant durability can be implemented after curing.

The polyamic acid composition may have a coefficient of thermal expansion (CTE) of 40 ppm/° C. or less after curing. In an embodiment, the upper limit of the CTE may be 40 ppm/° C., 35 ppm/° C., 30 ppm/° C., 25 ppm/° C., 20 ppm/° C., 18 ppm/C, 15 ppm/° C., 13 ppm/° C., 10 ppm/° C., 8 ppm/° C., 7 ppm/° C., 6 ppm/° C., 5 ppm/° C., 4.8 ppm/° C., 4.3 ppm/C, 4 ppm/° C., 3.7 ppm/° C., 3.5 ppm/° C., 3 ppm/C, 2.8 ppm/° C., or 2.6 ppm/° C. or less, and the lower limit thereof may be, for example, 0.1 ppm/° C., 1 ppm/° C., 2.0 ppm/° C., 2.6 ppm/° C., 2.8 ppm/° C., 3.5 ppm/° C., or 4 ppm/° C. or more. In an example, the CTE may be measured at 100 to 450° C. The CTE may be measured using a thermomechanical analyzer (Q400 model commercially available from TA Instruments) and determined by preparing a polyimide film, cutting the film to a width of 2 mm and a length of 10 mm, and measuring the slope of the range from 100° C. to 450° C. while raising a temperature from room temperature to 500° C. at 10° C./min while applying a tension of 0.05 N under a nitrogen atmosphere, and then lowering the temperature at 10° C./min.

In addition, the polyamic acid composition may have an elongation of 10% or more after curing. In an embodiment, the elongation may be 12% or more, 13% or more, 15% or more, 18% or more, 20 to 60%, 20 to 50%, 20 to 40%, 20 to 38%, 22 to 36%, 24 to 33%, or 25 to 29%. The elongation may be measured using Instron 5564 UTM equipment commercially available from Instron in accordance with ASTM D-882 after the polyamic acid composition is cured to prepare a polyimide film, and the polyimide film is cut to a width of 10 mm and a length of 40 mm.

Additionally, the polyamic acid composition according to the present application may have an elastic modulus of 6.0 GPa to 11 GPa after curing. The lower limit of the elastic modulus may be, for example, 6.5 GPa, 7.0 GPa, 7.5 GPa, 8.0 GPa, 8.5 GPa, 9.0 GPa, 9.3 GPa, 9.55 GPa, 9.65 GPa, 9.8 GPa, 9.9 GPa, 9.95 GPa, 10.0 GPa, or 10.3 GPa or more, and the upper limit thereof may be, for example, 10.8 GPa, 10.5 GPa, 10.2 GPa, or 10.0 GPa or less. Also, the polyamic acid composition may have a tensile strength of 300 MPa to 600 MPa after curing. The lower limit of the tensile strength may be, for example, 350 MPa, 400 MPa, 450 MPa, 480 MPa, 500 MPa, 530 MPa, or 540 MPa or more, and the upper limit thereof may be, for example, 580 MPa, 570 MPa, 560 MPa, 545 MPa, 530 MPa, or 500 MPa or less. The elastic modulus and tensile strength may be measured using Instron 5564 UTM equipment commercially available from Instron in accordance with ASTM D-882 after the polyamic acid composition is cured to prepare a polyimide film, and the polyimide film is cut to a width of 10 mm and a length of 40 mm. In this case, the measurement may be made at a cross head speed of 50 mm/min.

In an example, the polyamic acid composition according to the present application may have a glass transition temperature of 300° C. or more after curing. The upper limit of the glass transition temperature may be 800° C. or 700° C. or less, and the lower limit thereof may be 320° C., 330° C., 340° C., 360° C., 365° C., 370° C., 380° C., 390° C., 400° C., 410° C., 420° C., 425° C., 430° C., 440° C., 445° C., 448° C., 450° C., 453° C., 455° C., or 458° C. The glass transition temperature may be determined by measuring a polyimide prepared by curing the polyamic acid composition under a condition of 10° C./min using a TMA.

The polyamic acid composition according to the present application may have a 1 wt % thermal decomposition temperature of 500° C. or more after curing. The thermal decomposition temperature may be measured using a thermogravimetric analyzer (Q50 model commercially available from TA Instruments). In an embodiment, a polyimide prepared by curing polyamic acid is subjected to moisture removal while raising a temperature to 150° C. at 10° C./min under a nitrogen atmosphere and then maintaining the temperature for 30 minutes. Afterward, the temperature is raised to 600° C. at 10° C./min, and a temperature at which a weight loss of 1% occurs is measured. The lower limit of the thermal decomposition temperature may be, for example, 510° C., 515° C., 518° C., 523° C., 525° C., 528° C., 530° C., 535° C., 538° C., 545° C., 550° C., 560° C., 565° C., 568° C., 570° C., 580° C., 583° C., 585° C., 588° C., 590° C., or 593° C. or more, and the upper limit thereof may be, for example, 800° C., 750° C., 700° C., 650° C., or 630° C. or less.

In addition, the polyamic acid composition according to the present application may have a light transmittance of 50 to 80% in any one wavelength range in the visible light region (380 to 780 nm) after curing. The lower limit of the light transmittance may be, for example, 55%, 58%, 60%, 62%, 63%, 64%, 65%, 66%, 67%, 68%, 69%, 70%, or 71% or more, and the upper limit thereof may be, for example, 78%, 75%, 73%, 72%, 71%, 69%, 68%, 67%, 66%, 65%, or 64% or less.

In addition, the present application relates to a method of preparing a polyamic acid composition, which may be a method of preparing the above-described polyamic acid composition.

The preparation method includes performing heating at 50° C. or more. The heating may be performed, for example, at 55° C. or more, 58° C. or more, 60° C. or more, 63° C. or more, 65° C. or more, or 68° C. or more, and the upper limit of the temperature may be, for example, 100° C. or less, 98° C. or less, 93° C. or less, 88° C. or less, 85° C. or less, 83° C. or less, 80° C. or less, 78° C. or less, 75° C. or less, 73° C. or less, or 71° C. or less. In the present application, before the heating, mixing an organic solvent and a dianhydride monomer component may be included. In the present application, the above-described heating may be performed after the mixing, and accordingly, the heating may be performed while an organic solvent and a dianhydride monomer are included. Since the present application further includes performing a high-temperature heating step as compared with a conventional process, a desired polyamic acid structure can be achieved, the length of the entire polymer chain can be increased after curing, and the polymer can implement excellent heat resistance, dimensional stability, and mechanical properties.

In an embodiment, the method of preparing a polyamic acid composition according to the present application may have, for example, the following polymerization methods:
(1) a polymerization method in which the entire amount of a diamine monomer is added to a solvent, and then a dianhydride monomer is added so that the number of moles of the dianhydride monomer is substantially equal to that of the diamine monomer;
(2) a polymerization method in which the entire amount of a dianhydride monomer is added to a solvent, and then a diamine monomer is added so that the number of moles of the diamine monomer is substantially equal to that of the dianhydride monomer;
(3) a polymerization method in which some of a diamine monomer component is added to a solvent, some of a dianhydride monomer component is mixed in an amount of about 95 to 105 mol % relative to the reaction component, the remaining diamine monomer component is added, and the remaining dianhydride monomer component is subsequently added so that the number of moles of the diamine monomer and the number of moles of the dianhydride monomer are substantially equal;
(4) a polymerization method in which a dianhydride monomer is added to a solvent, some of a diamine monomer component is mixed in an amount of 95 to 105 mol % relative to the reaction component, another dianhydride monomer component is added, and the remaining diamine monomer component is subsequently added so that the number of moles of the diamine monomer and the number of moles of the dianhydride monomer are substantially equal; and
(5) a polymerization method in which a first composition is formed by reacting some of a diamine monomer component and some of a dianhydride monomer component in a solvent so that the amount of any one of them is excessive, a second composition is formed by reacting some of a diamine monomer component and some of a dianhydride monomer component in another solvent so that the amount of any one of them is excessive, the first and second compositions are mixed, and polymerization is completed, wherein, when the amount of the diamine monomer component is excessive in the formation of the first composition, the dianhydride monomer component is used in an excessive amount in the formation of the second composition, and when the amount of the dianhydride monomer component is excessive in the formation of the first composition, the diamine monomer component is used in an excessive amount in the formation of the second composition, and the first and second compositions are mixed so that the number of moles of the entire diamine monomer component used in the reaction is substantially equal to that of the entire dianhydride monomer component.

The polymerization method is not limited to the above examples, and any known method may be used.

The preparation of a polyamic acid composition may be performed at 30 to 80° C.

In addition, the present application relates to a polyimide including a cured product of the polyamic acid composition. Also, the present application provides a polyimide film including the polyimide. The polyimide film may be a polyimide film for a substrate, and in an embodiment, may be a polyimide film for a TFT substrate.

In addition, the present invention provides a method of preparing a polyimide film, which includes: coating a support with a polyamic acid composition prepared by the method of preparing a polyamic acid composition, drying the composition to prepare a gel film, and curing the gel film.

Specifically, in the method of preparing a polyimide film according to the present invention, the coating of a support with a polyimide precursor composition, drying of the composition to prepare a gel film, and curing of the gel film may be performed by drying the polyimide precursor composition applied on the support at 20 to 120° C. for 5 to 60 minutes to prepare a gel film, heating the gel film to 30 to 500° C. at 1 to 8° C./min, thermally treating the heated film at 450 to 500° C. for 5 to 60 minutes, and cooling the thermally treated film to 20 to 120° C. at 1 to 8° C./min.

The curing of the gel film may be performed at 30 to 500° C. For example, the curing of the gel film may be performed at 30 to 400° C., 30 to 300° C., 30 to 200° C., 30 to 100° C., 100 to 500° C., 100 to 300° C., 200 to 500° C., or 400 to 500° C.

The polyimide film may have a thickness of 10 to 20 μm. For example, the polyimide film may have a thickness of 10 to 18 μm, 10 to 16 μm, 10 to 14 μm, 12 to 20 μm, 14 to 20 μm, 16 to 20 μm, or 18 to 20 μm.

The support may be, for example, an inorganic substrate, the inorganic substrate may be a glass substrate or a metal substrate, and a glass substrate is preferably used. As the glass substrate, soda-lime glass, borosilicate glass, alkali-free glass, or the like may be used, but the present invention is not limited thereto.

### Advantageous Effects

The present application relates to a polyamic acid composition, and provides a polyamic acid composition, which has a high concentration of polyamic acid solid and low viscosity and is excellent in heat resistance, dimensional stability, and mechanical properties after curing, and a polyimide and a polyimide film, which are prepared therefrom.

### MODES OF THE INVENTION

Hereinafter, the present invention will be described in further detail by way of examples according to the present invention and comparative examples, but the scope of the present invention is not limited by the examples presented below.

### <Preparation of Polyamic Acid Solution>

### Example 1

N-methyl-pyrrolidone (NMP) as a first solvent was input into a 500 ml reactor equipped with a stirrer and a nitrogen inlet and outlet while injecting nitrogen, and then methanol (MeOH) as a second solvent was input in an amount of 1 wt % (NMP 99 wt %) and stirred. After the temperature of the reactor was set to 70° C., biphenyltetracarboxylic dianhydride (BPDA) as a dianhydride monomer was input and allowed to react. Subsequently, a temperature was lowered to 30° C. under a nitrogen atmosphere, and p-phenylenediamine (PPD) as a diamine monomer was completely dissolved in the reaction solution and rapidly stirred. Afterward, the stirring was continued for 120 minutes while a temperature was raised to 40° C., thereby preparing a polyamic acid solution.

### Examples 2 to 6

A polyamic acid solution was prepared in the same manner as in Example 1, except that monomers, the content ratio, and addition solvents were adjusted as shown in Table 1. In the case of the second solvent, only the type of solvent was changed, and the content was the same at 1 wt %.

### Comparative Examples 1 to 5

A polyamic acid solution was prepared in the same manner as in Example 1, except that monomers, the content ratio, and addition solvents were adjusted as shown in Table 1. In the case of the second solvent, only the type of solvent was changed, and the content was the same at 1 wt %.

TABLE 1

| | Diamine | | | Dianhydride | | | |
|---|---|---|---|---|---|---|---|
| | ODA | BAPP | PPD | BPDA | PMDA | BTDA | Second solvent |
| | (mol %) | (mol %) | (mol %) | (mol %) | (mol %) | (mol %) | (1 wt %) |
| Example 1 | | | 100 | 100 | | | Methanol |
| Example 2 | | | 100 | 100 | | | EA |
| Example 3 | 100 | | | | 100 | | MTBE |
| Example 4 | | | 100 | 50 | 50 | | DMC |
| Example 5 | | 100 | | | 70 | 30 | MMA |
| Example 6 | 100 | | | 100 | | | PGMEA |
| Comparative | | | 100 | 100 | | | CHN |
| Example 1 | | | | | | | |
| Comparative | 100 | | | | 100 | | DCB |
| Example 2 | | | | | | | |
| Comparative | | | 100 | 50 | 50 | | AP |
| Example 3 | | | | | | | |
| Comparative | | 100 | | | 70 | 30 | DMSO |
| Example 4 | | | | | | | |
| Comparative | 100 | | | 100 | | | NB |
| Example 5 | | | | | | | |

ODA: 4,4′-oxydianiline
BAPP: 2,2-bis[4-(4-aminophenoxy)phenyl]propane
PPD: p-phenylenediamine
BPDA: biphenyltetracarboxylic dianhydride
PMDA: pyromellitic dianhydride
BTDA: benzophenone-3,4,3′,4′-tetracarboxylic dianhydride
EA: ethyl acetate (boiling point: 77° C.)
MTBE: methyl t-butyl ether (boiling point: 55° C.)
DMC: dimethyl carbonate (boiling point: 90° C.)
MMA: methyl methacrylate (boiling point: 100° C.)
PGMEA: propylene glycol monomethyl ether acetate (boiling point: 146° C.)
CHN: cyclohexanone (boiling point: 155° C.)
DCB: 1,2-dichlorobenzene (boiling point: 180° C.)
AP: acetophenone (boiling point: 202° C.)
DMSO: dimethyl sulfoxide (boiling point: 190° C.)
NB: nitrobenzene (boiling point: 210° C.)

### <Preparation of Polyimide for Measuring Material Properties>

Each polyamic acid composition prepared in the examples and comparative examples was subjected to air bubble removal through high-speed rotation at 1,500 rpm or more. Afterward, the deaerated polyamic acid composition was applied on a glass substrate using a spin coater. Then, the composition was dried under a nitrogen atmosphere at a temperature of 120° C. for 30 minutes to prepare a gel film, and the gel film was heated to 450° C. at 2° C./min, thermally treated at 450° C. for 60 minutes, and cooled to 30° C. at 2° C./min to obtain a polyimide film.

Afterward, the polyimide film was dipped in distilled water to peel the polyimide film from the glass substrate. Material properties of the prepared polyimide film were measured by the following methods, and results thereof are shown in Table 2 below.

### Experimental Example 1—Viscosity

The viscosities of the polyimide precursor compositions prepared in the examples and comparative examples were measured under conditions of a shear rate of 1/s, a temperature of 23° C., and a plate gap of 1 mm using Rheostress 600 commercially available from Haake.

### Experimental Example 2—CTE

A thermomechanical analyzer (Q400 model commercially available from TA Instruments) was used, and a CTE was determined by cutting the polyimide film to a width of 2 mm and a length of 10 mm, and measuring the slope of the range from 100° C. to a Tg temperature while raising a temperature from room temperature to 500° C. at 10° C./min while applying a tension of 0.05 N under a nitrogen atmosphere, and then lowering the temperature at 10° C./min.

### Experimental Example 3—Glass Transition Temperature

The glass transition temperatures of the polyimide films prepared in the examples and comparative examples were determined by measuring a rapidly expanding point under a condition of 10° C./min as an on-set point using a TMA.

### Experimental Example 4—1 wt % Thermal Decomposition Temperature (Td)

A thermogravimetric analyzer (Q50 model commercially available from TA Instruments) was used, and the polyimide film was subjected to moisture removal while a temperature was raised to 150° C. at 10° C./min under a nitrogen atmosphere and then maintained for 30 minutes. Afterward, a temperature was raised to 600° C. at 10° C./min, and a temperature at which a weight loss of 1% occurred was measured.

TABLE 2

| | Viscosity | CTE | Tg | Td |
|---|---|---|---|---|
| | (cP) | (ppm/° C.) | (° C.) | (° C.) |
| Example 1 | 3,500 | 4.6 | 466 | 588 |
| Example 2 | 5,100 | 5.7 | 470 | 590 |
| Example 3 | 5,000 | 23 | 365 | 530 |
| Example 4 | 4,300 | 3.5 | 450 | 594 |
| Example 5 | 2,000 | 15 | 405 | 520 |
| Example 6 | 8,500 | 25 | 380 | 540 |
| Comparative | 18,000 | 41 | 336 | 567 |
| Example 1 | | | | |
| Comparative | 12,000 | 32 | 290 | 487 |
| Example 2 | | | | |
| Comparative | 34,000 | 28 | 375 | 550 |
| Example 3 | | | | |
| Comparative | 45,000 | 48 | 288 | 525 |
| Example 4 | | | | |
| Comparative | 26,000 | 55 | 270 | 480 |
| Example 5 | | | | |

1. A polyamic acid composition comprising polyamic acid including a dianhydride monomer component and a diamine monomer component as a polymerization unit and a solvent,
wherein the solvent includes a first solvent having a boiling point of 150° C. or more and a second solvent having a boiling point lower than that of the first solvent.

2. The polyamic acid composition of claim 1, wherein the second solvent has a boiling point of 30° C. or more and less than 150° C.

3. The polyamic acid composition of claim 1, wherein the second solvent has at least one polar functional group selected from the group consisting of a hydroxyl group, a carboxyl group, an alkoxy group, an ester group, and an ether group.

4. The polyamic acid composition of claim 1, wherein the second solvent is included in an amount of 0.01 to 10 wt % in the entire polyamic acid composition.

5. The polyamic acid composition of claim 1, wherein the dianhydride monomer includes an unpolymerized monomer having a ring-opening structure in addition to the monomer included in the polymerization unit.

6. The polyamic acid composition of claim 5, wherein the dianhydride monomer having a ring-opening structure participates in an imidization reaction.

7. The polyamic acid composition of claim 1, wherein the diamine monomer includes 1,4-diaminobenzene (PPD), 1,3-diaminobenzene (MPD), 2,4-diaminotoluene, 2,6-diaminotoluene, 4,4′-diaminodiphenyl ether (ODA), 4,4′-methylenediamine (MDA), 4,4-diaminobenzanilide (4,4-DABA), N,N-bis(4-aminophenyl)benzene-1,4-dicarboxamide (BPTPA), 2,2-dimethylbenzidine (M-TOLIDINE), or 2,2-bis(trifluoromethyl)benzidine (TFDB).

8. The polyamic acid composition of claim 1, wherein the dianhydride monomer includes pyromellitic dianhydride (PMDA), 3,3′,4,4′-biphenyltetracarboxylic dianhydride (s-BPDA), 2,3,3′,4′-biphenyltetracarboxylic dianhydride (a-BPDA), 3,3′,4,4′-benzophenonetetracarboxylic dianhydride (BTDA), oxydiphthalic dianhydride (ODPA), 4,4-(hexafluoroisopropylidene)diphthalic anhydride (6-FDA), or p-phenylenebis(trimellitate anhydride) (TAHQ).

9. The polyamic acid composition of claim 1, which has a solid content of 9 to 35%.

10. The polyamic acid composition of claim 1, which has a viscosity of 500 cP to 50,000 cP as measured at a temperature of 23° C. and a shear rate of 1 s⁻¹.

11. The polyamic acid composition of claim 1, which has a weight-average molecular weight of 10,000 g/mol to 500,000 g/mol.

12. The polyamic acid composition of claim 1, further comprising inorganic particles.

13. The polyamic acid composition of claim 1, which has a coefficient of thermal expansion (CTE) of 40 ppm/° C. or less after curing.

14. The polyamic acid composition of claim 1, which has a glass transition temperature of 300° C. or more after curing.

15. A method of preparing the polyamic acid composition of claim 1, comprising performing heating at 50° C. or more.

16. A polyimide comprising a cured product of the polyamic acid composition of claim 1.

17. A polyimide film for a substrate, comprising the polyimide of claim 16.
